(19) United States
(12) Patent Application Publication
(10) Pub. No.: US 2022/0408762 A1
(43) Pub. Date: Dec. 29, 2022

(54) DEVICE FOR SIMULATING A FOOD

(71) Applicant: THE MARTIN BROWER COMPANY, LLC, Rosemont, IL (US)

(72) Inventors: Carole BENABENT, VENCE (FR); Thierry GUEHO, VANNES (FR); Alexandre BOISARD, CARQUEFOU (FR); Driss FARID, LE MANS (FR); Gérard DIVARET, GIF SUR YVETTE (FR); Gérald CAVALIER, NIMES (FR); Francis LANAUD, LAVANS-LES-DOLES (FR); Jean-François ASSIER, ARTIGUELOUVE (FR); Frantz LATCHAN, FRESNES (FR); Alessandro MARINOSCI, OSTUNI (IT); Chiara LAZZETTA, FRESNES (FR)

(21) Appl. No.: 17/621,464

(22) PCT Filed: Jun. 22, 2020
(86) PCT No.: PCT/FR2020/000189

§ 371 Date: Dec. 21, 2021

(30) Foreign Application Priority Data
Jun. 21, 2019 (FR) FR1906761

(51) Int. Cl. A23L 5/10

(52) U.S. Cl. CPC A23L 5/10

(57) ABSTRACT

The invention concerns a device (2) for simulating a food, comprising a sensor (9) for monitoring an internal parameter of the simulation device (2) and composed of a synthetic material (12) and an element (11). The proportions by mass of synthetic material (12) and element (11), as well as the type of synthetic material (12) and the type of liquid chosen, make it possible to mimic the behaviors of foods, in particular during cooking thereof and when they are subjected to temperature variations ranging from −20° C. to 110° C. According to the invention, the element (11) has a mass between 30% and 77% of a dry mass of the synthetic material (12). The invention is particularly suitable for meat foods comprising beef and/or poultry, but is suitable for any food for which the core cooking must be optimal, as is the case for foods preserved by freezing.

The technical context of the present invention is that of professional cooking equipment, in particular that of equipment to help the cooking of foods. More particularly, the invention relates to a device for simulating a food.

In the context of the catering trade, the cooking of foods is a key variable that must be monitored in order to guarantee the quality of the dish for the consumer. This is particularly the case for pre-frozen products.

Generally, cooking is controlled by means of a measurement of the core temperature of the food. This control is even more important in the case of a meat product for which, whether for reasons of taste or health, controlling the core temperature is crucial. In the case of frozen ground beef of the type consisting of disks of ground meat, the burgers are stored by freezing at about −18° C. before being cooked at a temperature of about 110° C., until reaching an optimal core temperature of between 69° C. and 74° C.

In the context of conventional catering such as the fast food industry, when setting up the service or during service, catering operators are required to calibrate their cooking equipment in order to cook the foods as perfectly as possible. At present, catering operators carry out successive tests using test foods that are identical to the foods that will be cooked for customers and consumed. Thermometers provided with a penetration probe allow the core temperature of foods to be measured during and/or at the end of cooking. The test foods used during these tests are then discarded.

The drawbacks of this method are economic, social and environmental. Every day, a large amount of test food is discarded following operations to calibrate the cooking equipment. In the context of the sustainable consumption of products and in particular of edible products, the invention aims to help limit this waste of foodstuffs.

The object of the present invention is to propose a device for simulating a food that allows the test food to be substituted in order to respond at least in large part to the above-mentioned problems and to lead to further advantages.

An object of the invention is to obtain a reusable solution for calibrating the cooking equipment through a simulation device that reproduces as closely as possible the characteristics of the test food, and in particular its thermophysical parameters, during variations in cooking temperature. In particular, the solution proposed by the invention is intended to be a substitute for meat foods, such as beef or poultry, for which at present the economic impact is significant.

Another object of the invention is to obtain a compliant solution that can be used with food products and that meets the health requirements for a catering establishment. The proposed solution must respect the health, food safety and safety regulations concerning food handling by catering operators.

Another object of the invention is to obtain a solution that is easy to use in order not to increase installation time in the kitchen for the catering operator, whether during service or prior to service.

Another object of the invention is to obtain an accurate solution capable of informing catering operators just as reliably as with test foods.

Another object of the invention is to obtain an ergonomic solution that meets the expectations of catering operators and that respects operational standards in the catering industry.

Another object of the invention is to obtain an all-purpose solution suited to any kind of catering, whether conventional or fast, and suited to eating habits anywhere in the world.

According to a first aspect of the invention, at least one of the above-mentioned objects is achieved with a device for simulating a food comprising (i) a body formed by at least one synthetic material, the at least one synthetic material being configured to be solid at a temperature of between −20° C. and 110° C. and an element housed in the body, the element being liquid at ambient temperature; and (ii) a sensor configured to measure data representative of a parameter of the body, the sensor being housed in the body.

The simulation device according to the first aspect of the invention is configured to mimic the thermophysical properties of the foods, such as notably their thermal conductivity. In particular, the simulation device according to the first aspect of the invention is particularly suited to simulating meat foods, owing to the synthetic material(s) and the element contained therein, which confer thermal conductivity equivalent to that of meat foods. Of course, the simulation device according to the first aspect of the invention could also mimic the thermophysical properties of other foods, by varying the element and the type of synthetic material composing said simulation device.

The body of the simulation device according to the first aspect of the invention simulates the food, in shape and in dimensions. The body is configured so that it can be frozen at −20° C., as a food may be for preservation purposes. The body is also configured so that it can be heated to a high temperature of up to 110° C., as a food may be when cooked. The simulation device according to the first aspect of the invention is particularly suited to fast cooking on a heat conduction cooking device such as a griddle, or on a radiant heat cooking device such as a grill, barbecue or salamander. More generally, the simulation device according to the first aspect of the invention may also be used for other types of fast or slow cooking, up to 110° C. In particular, cooking by roasting, cooking slowly whilst covered, cooking in a sauteuse, cooking by frying, by smoking, by drying, by poaching, by steaming or under vacuum may be mentioned.

The synthetic material(s) forming the body of the simulation device according to the first aspect of the invention has or have heat-resistant properties ensuring a solid state at a low temperature of down to −20° C. plus or minus 10%, and at a high temperature of up to 110° C. plus or minus 10%. “Solid state” should be understood to mean that the synthetic material(s) are heat resistant between −20° C. and 110° C., in the sense that said materials are in the state of aggregation that retains some consistency. Its molecules remain cohesive between −20° C. and 110° C., such that the body formed by the synthetic material(s) can be easily handled by a catering operator with the usual tools used in the kitchen for handling foods.

The at least one synthetic material of the simulation device according to the first aspect of the invention is a polymer-type material. The synthetic material is chosen so as to be compatible with a food use and easy to clean.

The sensor of the simulation device according to the first aspect of the invention allows at least one quantifiable physical parameter representative of the body to be measured, and corresponding to the measured data. The sensor is housed in the body so as to measure data at the core of the body of the simulation device according to the first aspect of the invention.

The data measured are representative of at least one of the thermophysical properties of the food mimicked. For example, the thermophysical properties measured by the sensor are properties such as temperature and/or degree of humidity.

The element is “liquid” at ambient temperature, in other words between 15° C. and 22° C., plus or minus 10%. It is possible for the element to adopt states other than the liquid state between −20° C. and 110° C. without harming the operation of the simulation device according to the first aspect of the invention.

The element advantageously comprises water.

The element is housed in the body. “Housed” should be understood to mean that the body comprises a dry mass of at least a synthetic material with the addition of an element. The element may be different from the dry mass of the synthetic material or may equally well be immiscible in the dry mass of the synthetic material. For example, the element is inserted between the polymers of the synthetic material.

The mass of the element is preferably between 30% and 77% of the dry mass of the at least one synthetic material, plus or minus 10%.

In a particularly advantageous way, the mass of the element is stable between −20° C. and 110° C., whatever the state of the element. In this sense, despite the temperature variations that could be applied to the simulation device according to the first aspect of the invention in day-to-day use, the simulation device mimics the thermophysical properties of meat foods despite a succession of different freezing and cooking cycles. The simulation device according to the first aspect of the invention is therefore reusable. A stable mass of the element ensures durability of use of the simulation device according to the first aspect of the invention. For example, the mass of the element is made stable when the at least one synthetic material is impermeable to liquids whatever the temperature of use of the simulation device between −20° C. and 110° C.

The simulation device according to the first aspect of the invention advantageously comprises at least one of the improvements below, and the technical characteristics forming said improvements may be taken alone or in combination:
the element is impregnated in the at least one synthetic material so as together to form an emulsion;
the sensor is a temperature sensor. The temperature sensor is suitable for measuring a temperature beyond a range of between −20° C. and 110° C., for example between −40° C. and 130° C. The temperature sensor allows the temperature of the simulation device according to the first aspect of the invention to be measured. It is therefore possible to monitor a change in temperature of the body of the simulation device throughout the cooking process, and in particular when the simulation device reaches a given temperature. For example, it is possible to identify a temperature of between 69° C. and 75° C., in particular at the core of the simulation device according to the first aspect of the invention when the temperature sensor is positioned in that spot. A temperature of between 69° C. and 74° C. reveals that the core of a meat food such as a beef or poultry burger is cooked;
the temperature sensor is a thermocouple in order to meet the health and safety requirements linked to use in a food setting;
in a first embodiment, the sensor is a wired sensor. The wired sensor comprises a probe housed in the body. The probe, configured to detect and measure a parameter of the body, is connected electrically by means of at least one electric wire to a data acquisition station, the at least one electric wire being configured to transport an electric signal representative of the parameter of the body measured by the probe and corresponding to the data measured. The wired sensor ensures easy, inexpensive and stable transmission of the data measured to the data acquisition station. Advantageously, the first end of the probe is rigidly connected to the body. In particular, the first end of the probe is connected non-removably to the body, for example by being included in the at least one synthetic material. By being rigidly connected to the body, the probe and/or the sensor adopt a stable position in the simulation device according to the first aspect of the invention, ensuring that the measurement can be reproduced. In a second alternative embodiment to the first embodiment, the sensor is wireless. When wireless, the sensor is housed in a chip inserted in the simulation device according to the first aspect of the invention. The chip also comprises a transmitter configured to communicate the data measured by the sensor to a data acquisition station. In particular, the transmitter may be a Bluetooth, Wi-Fi or RFID device. The wireless sensor makes the simulation device easier to handle;
the at least one synthetic material is impregnated by the element. The element is in this case mixed with the at least one synthetic material. The element replaces at least in part the air between the polymers of the at least one synthetic material, which has the advantage of increasing the thermal conductivity of the body and/or of improving the phase change of the body. Advantageously, the at least one synthetic material is hydrated, in other words impregnated with water, the element being in this case water;
the at least one synthetic material comprises methylcellulose;
the element is between 70% and 80% of the dry mass of the at least one synthetic material. Preferably, the element is equal to 76.4% of the dry mass of the at least one synthetic material. This element percentage is particularly advantageous when the synthetic material comprises methylcellulose;
the at least one synthetic material comprises silicon, the element state housed in a housing of the body. If the synthetic material comprises silicon, the element is preferably confined in the housing. The housing is advantageously closed, so as to isolate the element from the environment outside of the body and/or relative to some other portions of the body. The housing is dimensioned so as to contain at least the element in the proportions according to the first aspect of the invention, whatever the state of dilation of the element and between −20° C. and 110° C. The housing may also contain a gaseous portion, such as air, or a vacuum. The dimensions of the housing may vary according to the temperatures to which the simulation device according to the first aspect of the invention is subjected. For example, the synthetic material is configured to plastically deform when subject to the expansion or contraction of the element;
the housing is positioned at a central area of the body. The housing is positioned at the core of the body, in other words at a distance from the periphery of the body;
the housing is advantageously divided into a plurality of cavities separated from one another by ribs. The plurality of cavities ensures a better distribution of the element in the body of the simulation device according to the first aspect of the invention. Moreover, this type of division of the housing into a plurality of cavities allows the temperature of the element to homogenize more rapidly within each cavity compared with a single housing when the simulation device according to the invention is subjected to a change in temperature. The shapes, dimensions and positions of the cavities in the body may be of any kind in the context of the invention. In particular, according to a first embodiment, the cavities are distributed in the body in segments about a central axis of the plurality of cavities. In a second embodiment, alternative or complementary to the first embodiment, the cavities of the plurality of cavities are formed by concentric annular areas. For example, the cavities may form evenly segmented annular areas about the central axis of the plurality of cavities;
the ribs are preferably formed of the same synthetic material as the body;
a water mass of the element is between 10 g and 17 g per 31 g of silicon forming the at least one synthetic material of the body. This proportion allows thermophysical properties of the simulation device to be proposed, in particular in response to temperature variations comparable to those of meat foods such as beef or poultry. Advantageously, the water mass is 12 g per 31 g of silicon;
the synthetic material comprises an additive. The additive allows the physical characteristics of the synthetic material to be modified. The additive allows the thermal performance of the synthetic material to be improved and/or the additive allows the behavior of the synthetic material, such as its expansion or flexibility, to be improved with regard to temperature variations. In a non-limiting manner, the additive is selected, alone or in combination, from air, water, a salt, an oil or solid particles such as metal particles;
the simulation device according to the first aspect of the invention comprises a heat diffusion device housed in the body. The heat diffusion device is configured to enhance temperature homogenization within the body. The heat diffusion device has greater thermal conductivity than the at least one synthetic material and/or the element. The heat diffusion device is housed at the lower face of the body whereas the housing for the element is housed opposite, at the upper face of the body. Advantageously, the dimensions of the heat diffusion device are smaller than those of the lower face of the body so as to be contained in the body;
the heat diffusion device extends along the largest of the dimensions of the simulation device according to the first aspect of the invention. Thus, the heat diffusion device homogenizes the temperature along the entire length of the body;
the heat diffusion device comprises a metal device. The metal device has a good thermal conductivity coefficient. Advantageously the metal device comprises aluminum;
the metal device comprises a sheet. Advantageously the sheet is a wafer, in other words a sheet of negligible thickness relative to the other dimensions of the sheet;
the sheet forming the metal device is advantageously solid. Alternatively, the sheet forming the metal element is punched with holes in order to lighten said sheet;
the body forming the simulation device according to the first aspect of the invention has a cylindrical shape. The cylindrical shape is similar to that of a ground beef burger;
the body has a longitudinal dimension of between 8 cm and 14 cm and a lateral dimension of between 0.2 cm and 1.5 cm. These dimensions are those traditionally found in a burger. The longitudinal dimension is the largest dimension in which the body extends. The lateral dimension is perpendicular to the longitudinal dimension and extends between the lower face of the body and the upper face of the body. The lateral dimension corresponds to the thickness of the body and corresponds to the smallest dimension in which the body extends. Advantageously, the longitudinal dimension is 11 cm and the lateral dimension is 0.5 cm.

According to a second aspect of the invention, a device for monitoring the cooking of a food is proposed comprising at least one simulation device according to the first aspect of the invention, each simulation device being connected to a data acquisition station. In the monitoring device according to the second aspect of the invention, each simulation device according to the first aspect of the invention allows the data representative of the body of said simulation device to be measured and the data acquisition station allows these data to be restored for each of said simulation devices.

“Connected” should be understood to mean that the simulation device according to the first aspect of the invention and the data acquisition station are in communication with each other. Said simulation device and said data acquisition station may be electrically connected equally well via a wired or a wireless connection.

When the simulation devices according to the first aspect of the invention are connected by a wired link to the data acquisition station, the data acquisition station is in this case provided with connectors configured to allow non-permanent connection of an electric wire to said data acquisition station. Thus, the data acquisition station and the simulation device may be dissociated, in particular when the simulation devices are frozen or cleaned.

When a plurality of simulation devices according to the first aspect of the invention are comprised in the monitoring device according to the second aspect of the invention, each of said simulation devices is connected to said data acquisition station in the same way as the other simulation devices, either by a wired connection, or by a wireless connection.

The simulation devices are advantageously arranged electrically in parallel with one another relative to the data acquisition station.

The monitoring device according to the second aspect of the invention advantageously comprises at least one of the improvements below, and the technical characteristics forming said improvements may be taken alone or in combination:
the data acquisition station comprises a data processing module, the data processing module being configured to process data measured by a sensor of the simulation device according to the first aspect of the invention. The data processing module receives the data measured by the sensor of each simulation device according to the first aspect of the invention, then processes said data. For example, the data processing module compares the data measured to a reference value or values;
the data acquisition station comprises a data indicator. The data indicator receives the data processed by the data processing module, or receives the data measured by the sensor of the simulation device according to the first aspect of the invention directly and assumes a state that depends on the data measured and/or the reference value. The data indicator therefore informs the catering operator of the data measured or said processed data. The data indicator is configured to provide information on one or more items of data, for example an instantaneous item of data measured, and/or the last item of data measured, and/or data measured successively, and/or data measured in different simulation devices, and/or archived data;
the data indicator indicates a temperature when the sensor measures a temperature.
in a first embodiment, the data indicator is an indicator light. The indicator light may comprise one or more light sources of which the color emitted and/or the ignition frequency depend on the data measured and/or the reference values. In particular, the indicator light may be parameterized according to a data value to be attained. In the case of a burger simulation that needs to reach an optimal core temperature of between 64° C. and 74° C., the indicator light may be parameterized so as to emit a specific light when the monitoring device according to the second aspect of the invention equipped with a temperature sensor measures a temperature of between 64° C. and 74° C. In a second embodiment that is alternative or complementary to the first embodiment, the data indicator is a display of the value of said item of data. In this case, the data indicator displays a value expressed as numeric characters and/or in graphic form. In a third embodiment that is alternative or complementary to the first embodiment and/or to the second embodiment, the data indicator is a sound indicator. For example, the sound indicator may be parameterized to emit a sound when a data value to be attained actually is attained;
the data acquisition station is configured to be impermeable to dust and to water. “Impermeable to dust and to water” should be understood to mean that the data acquisition station is protected against dust and other microscopic residues and against water jets. This characteristic is advantageous in the context of use in catering and specifically in kitchens, an environment in which splashes of this type (water, grease residues, etc.) are frequent. Moreover, this characteristic allows the surface of the data acquisition station to be cleaned. According to a particularly advantageous example, the data acquisition station has an IP65 protection rating;
the monitoring device comprises an SD card data storage space. The storage space allows the data measured to be recorded and/or archived in order to allow restoration thereof after taking the measurement.

According to a third aspect of the invention, a method is proposed for controlling the cooking of a food using at least one simulation device according to the first aspect of the invention and/or using the monitoring device according to the second aspect of the invention, the method comprising the following steps: (i) a step of placing the device for simulating a food, during which the device for simulating a food is placed on a cooking device intended for cooking foods; (ii) a control step of the cooking device; (iii) a step, at a data acquisition frequency, of recording an item of data, during which the item of data measured by the sensor of the simulation device is recorded; (iv) a restoration step during which information on the item of data measured by the sensor of the simulation device is restored.

The step of placing the simulation device according to the first aspect of the invention replaces a step of placing the test food on the cooking device. Therefore, the simulation device used in this placing step has a core temperature identical or similar to that of the test food. In other words, the simulation device used in this placing step has a core temperature identical or similar to that of the foods that will be cooked on the cooking device after the control method according to the third aspect of the invention has been implemented. For example, if a food frozen at −20° C. is to be cooked on the cooking device, the simulation device used in this placing step is also frozen at −20° C. Ideally, the simulation device used in this placing step is therefore stored in the same conditions as the food simulated.

The control step of the cooking device allows the cooking device that is to be calibrated to be put into operation. It will be understood that the cooking device is taken, following the control step, to an optimal cooking temperature which will allow the foods that the simulation device according to the first aspect of the invention simulates to be cooked. The control step may be a cold start of the cooking device. For example, the cold start takes place when setting up in the kitchen, prior to service.

The control step may be an adjustment of the temperature of the cooking device which has already risen in temperature. For example, the temperature of the cooking device is adjusted during service, after having cooked a given number of foods.

The placing step may precede or succeed the control step of the cooking device. The cooking device may be calibrated prior to cooking the foods or during service to verify that the cooking temperature is still optimal.

The restoration step allows the catering operator to receive information. The catering operator calibrates the cooking device according to the information indicated.

The step of recording an item of data precedes the step of displaying that item of data.

The control method according to the third aspect of the invention advantageously comprises at least one of the improvements below, and the technical characteristics forming said improvements may be taken alone or in combination:
during the data recording step, when the control method is implemented by the monitoring device according to the second aspect of the invention, the item of data measured by the sensor of the simulation device is recorded by the data acquisition station of the monitoring device;
during the restoration step, when the control method is implemented by the monitoring device according to the second aspect of the invention, information on the item of data measured by the sensor of the simulation device is restored by the data acquisition station of the monitoring device according to the second aspect of the invention. More particularly, information on the item of data is restored by the data indicator of the data acquisition station of the monitoring device. For example, information on the item of data is luminous information restored by the indicator light, or numerical information when the inductor takes the form of a value display, or sound information when the indicator takes the form of a sound indicator;
during the recording step, when the control method is implemented by the monitoring device according to the second aspect of the invention, the data measured are recorded by the SD card data storage space. The storage space allows the data measured to be recorded so that said data may be restored after the measurement is taken, in particular during the restoration step;
the method according to the third aspect of the invention comprises a connection step during which the device for simulating a food is connected to the data acquisition station. The connection step allows the simulation device according to the first aspect of the invention to be connected to the data acquisition station. The connection step is implemented if the simulation device according to the first aspect of the invention comprises a removable wired sensor or if said simulation device comprises a wireless sensor. In the case of a wired sensor, the connection step allows the electric wire of the simulation device according to the first aspect of the invention to be connected to the connectors of the acquisition station. In the case of a wireless sensor, the connection step allows the transmitter of the simulation device according to the first aspect of the invention to be connected to the receiver of the acquisition station. The placing step may precede or succeed the connection step. The connection step may precede or succeed the control step of the cooking device. The connection step precedes the recording of the data;
the method according to the third aspect of the invention comprises a data processing step during which a data processing module of the monitoring device processes the item of data measured by the device for simulating a food;
the method according to the third aspect of the invention comprises a data processing step during which the data processing module of the monitoring device compares the item of data measured by the sensor of the device for simulating a food with a threshold value. For example, the monitoring device compares the temperature measured by the sensor of the simulation device with a threshold temperature value, for example a threshold value of 69° C. and/or a threshold value of 74° C.;
the method according to the third aspect of the invention comprises a warning step during which a data indicator indicates that an item of data measured by the sensor of the device for simulating a food exceeds the threshold value. For example, when a first temperature threshold value is exceeded, for example a threshold value of 69° C., the indicator light emits a first light signal, and when a second temperature threshold value is exceeded, for example a threshold value of 74° C., the indicator light emits a second light signal that is different from the first light signal. In another example, when a first temperature threshold value is exceeded, for example a threshold value of 69° C., the sound indicator emits a first sound signal, and when a second temperature threshold value is exceeded, for example a threshold value of 74° C., the sound indicator emits a second sound signal that is different from or similar to the first sound signal.

Various embodiments of the invention are provided for that incorporate, in all the possible combinations thereof, the different optional characteristics described here.

Other characteristics and advantages will also become apparent through the description that follows on the one hand, and on the other hand a plurality of embodiments given by way of non-limiting indicative examples with reference to the accompanying diagrammatic drawings, in which:

FIG. 1 is a diagrammatic view of a device for monitoring the cooking of a food according to the second aspect of the invention in accordance with a first embodiment and comprising a simulation device according to the first aspect of the invention;

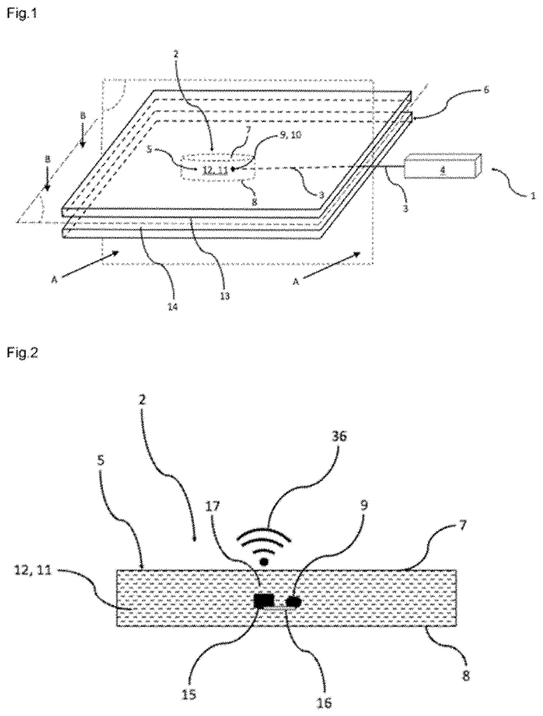

FIG. 2 is a diagrammatic view in transverse cross section of the simulation device according to the first aspect of the invention, in accordance with a first variant;

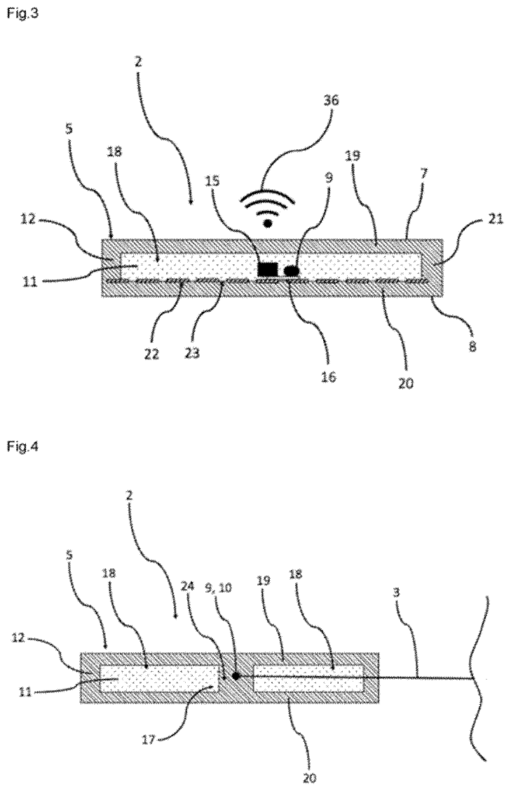

FIG. 3 is a diagrammatic view in transverse cross section of the simulation device according to the first aspect of the invention, in accordance with a second variant;

FIG. 4 is a diagrammatic view in transverse cross section of the simulation device according to the first aspect of the invention, in accordance with a third variant;

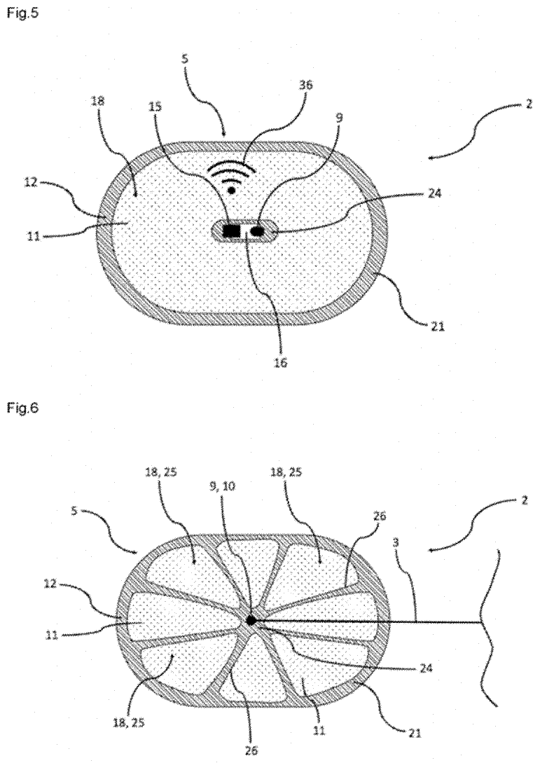

FIG. 5 is a diagrammatic view in longitudinal cross section of the simulation device according to the first aspect of the invention, in accordance with the third variant;

FIG. 6 is a diagrammatic view in longitudinal cross section of the simulation device according to the first aspect of the invention, in accordance with a fourth variant;

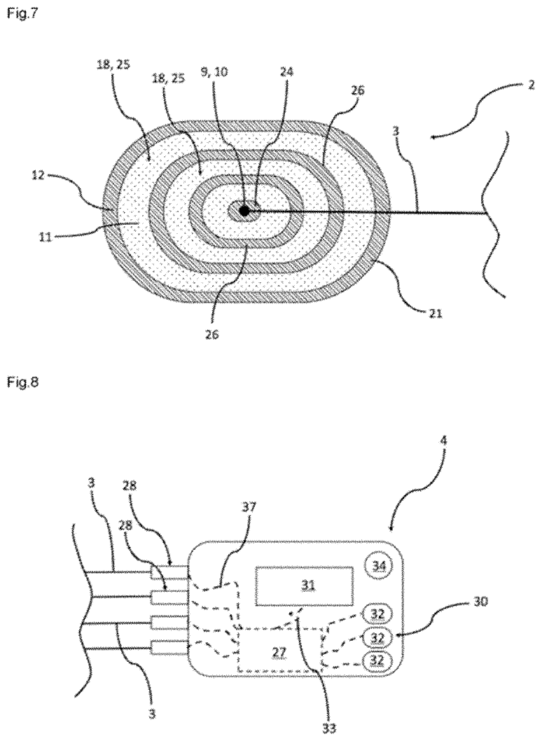

FIG. 7 is a diagrammatic view in longitudinal cross section of the simulation device according to the first aspect of the invention, in accordance with a fifth variant;

FIG. 8 is a diagrammatic view of a data acquisition station comprised in the device for monitoring the cooking of a food according to the second aspect of the invention;

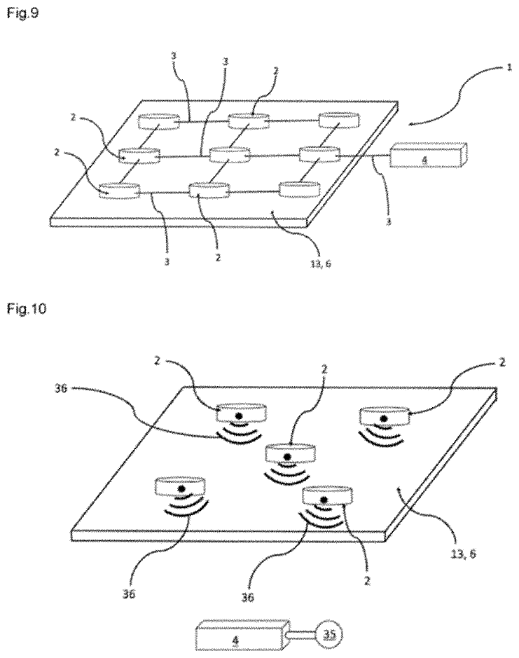

FIG. 9 is a diagrammatic view of the device for monitoring the cooking of a food according to the second aspect of the invention in accordance with a second embodiment and comprising a plurality of simulation devices according to the first aspect of the invention;

FIG. 10 is a diagrammatic view of the device for monitoring the cooking of a food according to the second aspect of the invention in accordance with a third embodiment and comprising a plurality of simulation devices according to the first aspect of the invention.

Of course, the characteristics, variants and different embodiments of the invention may be associated with one another, in various combinations, provided that they are not incompatible or exclusive of one another. In particular variants of the invention may be envisaged that comprise only a selection of the characteristics described below isolated from the other characteristics described, if said selection of characteristics is sufficient to confer a technical advantage or to differentiate the invention relative to the prior art.

In particular, all the variants and embodiments described may be combined with one another if said combination is not in conflict in technical terms.

In the figures, elements common to more than one figure retain the same reference.

With reference to FIG. 1, the invention is shown in a first embodiment with a device 1 for monitoring the cooking of a food according to the second aspect of the invention. The monitoring device 1 comprises a simulation device 2 according to the first aspect of the invention connected by an electric wire 3 to a data acquisition station 4 of which an embodiment is described in FIG. 8.

The simulation device 2 comprises a body 5 which is placed on a cooking device 6. The body 5 takes the form of a cylinder mimicking the shape of a burger-type meat food. The body 5 thus comprises an upper face 7 and a lower face 8 opposite the upper face 7, the lower face 8 and the upper face 7 forming the bases of the cylinder, and being similar in shape and dimensions.

The body 5 is formed by at least one synthetic material 12 configured to be solid at a temperature of between −20° C. and 110° C. In other words, the at least one synthetic material 12 is solid both when frozen and when subjected to the heat of the cooking device 6. Moreover, the at least one synthetic material 12 is characterized by a dry mass.

The simulation device 2 comprises a sensor 9. The sensor 9 is configured to measure data representative of a parameter of the body 5, the sensor 9 being housed in the body 5 as shown in FIGS. 2 to 7. As shown in FIG. 1, the sensor 9 is a wired sensor which comprises a probe 10 housed in the body 5 as described in FIG. 3. The probe 10 is configured to measure a parameter of the body 5 and is connected electrically to the data acquisition station 4. In this particular case, the sensor 9 is a wired temperature sensor, provided with a probe 10 configured to measure a temperature of the body 5 of the simulation device 2. The temperature measured by the probe 10 is transmitted to the data acquisition station 4 in the form of an electric signal via the electric wire 3.

The body 5 of the simulation device 2 also comprises an element 11 housed in the body 5, as described in FIGS. 2 to 7. The element 11 is liquid at an ambient temperature of between 15° C. and 22° C. The element 11 advantageously has a mass of between 30% and 77% of the dry mass of the synthetic material 12.

The cooking device 6 takes the form of a griddle, and more particularly of a clam griddle. The clam griddle is configured to hold the foods between two cooking surfaces 13, 14, an upper surface 13 and a lower surface 14. During implementation of the clam-type cooking device 6, the two cooking surfaces 13, 14 are heated to temperatures that may reach 110° C. so as to cook both faces of the food simultaneously. In this particular case, the upper face 7 of the body 5 of the simulation device 2 according to the first aspect of the invention and the lower face 8 of said body 5 are both in contact with the cooking surfaces 13, 14, in contact respectively with the upper surface 13 and the lower surface 14.

When implementing the monitoring device 1 according to the second aspect of the invention. The data acquisition station 4 is arranged close to the cooking device 6 without however being positioned at the cooking surfaces 13, 14. The electric wire 3, which is positioned in part between the two cooking surfaces 13, 14 is thermally insulated to retain its electrical conductivity properties and maintain its integrity. For example, the electric wire 3 comprises a thermally insulating sheath.

FIG. 2, FIG. 3, FIG. 4, FIG. 5, FIG. 6 and FIG. 7 are illustrations in cross section of the simulation device 2 according to the first aspect of the invention in different embodiments. FIG. 2, FIG. 3 and FIG. 4 are each a transverse cross section along AA as shown in FIG. 1. FIG. 5, FIG. 6 and FIG. 7 are each a longitudinal cross section along BB as shown in FIG. 1.

FIG. 2 shows the body 5 of the simulation device 2 according to the first aspect of the invention and in a first embodiment. The body 5 is solid, in other words completely filled with the synthetic material 12. In this particular case, the at least one synthetic material 12 comprises methylcellulose impregnated by the element 11, in other words the element 11 is distributed in the at least one synthetic material 12, between the methylcellulose polymers so as to form an emulsion. For example, the element 11 comprises water, and corresponds to 76.4% of the dry mass of the synthetic material 12.

FIG. 2 shows the sensor 9 of the simulation device 2 according to the first aspect of the invention. The sensor 9 is a wireless sensor, associated with a wave transmitter 15 configured to transmit waves 36. The wireless sensor and the transmitter 15 are both rigidly connected to a chip 16. The chip 16 for its part is immobilized in the at least one synthetic material 12, in a central area 17 of the body 5, in other words equidistant between the upper face 7 of the body 5 and the lower face 8 of the body 5.

FIG. 3 shows the body 5 of the simulation device 2 according to the second aspect of the invention and in a second embodiment. The at least one synthetic material 12 is made of silicon. The body 5 comprises a housing 18 housing the element 11. The housing 18 is delimited by an upper region 19 of the upper face side 7 of body 5, a lower region 20 of the lower face side 8 of the body 5 and a peripheral region 21 of the body 5 which connects the upper region 19 of the body 5 and the lower region 20 of the body 5. The upper region 19 of the body 5, the lower region 20 of the body 5 and the peripheral region 21 of the body 5 are made of the synthetic material 12.

FIG. 3 shows a heat diffusion device 22 housed in the body 5 of the simulation device 2 according to the second aspect of the invention. Said heat diffusion device 22 takes the form of a metal device of the metal wafer type. The heat diffusion device 22 is housed in the at least one synthetic material 12 so as to be secured in the body 5 whatever the state of dilation of the body 5. The heat diffusion device 22 is, in FIG. 3, advantageously punched with holes 23 traversing the heat diffusion device 22 and distributed evenly on the surface thereof.

In FIG. 3, the sensor 9 is as described in FIG. 4 and reference should be made to the figure to understand and implement the invention. The sensor 9 is rigidly connected to the heat diffusion device 22 via the chip 16, which allows the sensor 9 to be kept centered in the body 5 of the simulation device 2 according to the second aspect of the invention.

FIG. 4 shows the body 5 of the simulation device 2 according to the second aspect of the invention and in a third embodiment. The body 5 comprises the housing 18 housing the element 11 and the at least one synthetic material 12 is made of silicon. The element 11 in this case completely fills the housing 18, but it should be understood that the housing 18 may also house a gaseous portion or a solid portion, such as particles, in order to improve the thermal conductivity of the body 5.

FIG. 4 shows that the body 5 also comprises a central region 24 made of the at least one synthetic material 12, positioned at the central area 17 of the body. The central region 24 connects the upper region 19 of the body 5 and the lower region 20 of the body 5 at the central area 17 of the body. The sensor 9 of the simulation device 2 according to the first aspect of the invention is rigidly connected to the central region 24 being sunk in the at least one synthetic material 12.

In FIG. 4, the sensor 9 of the simulation device 2 according to the first aspect of the invention is a wired sensor comprising the probe 10. The probe 10 is positioned at the core of the body 5, held by the central region 24. The electric wire 3 which is connected to the probe 10 traverses in part the housing 18 and in part the at least one synthetic material 12.

FIG. 5 shows the body 5 of the simulation device 2 according to the second aspect of the invention and in a fourth embodiment. Said fourth embodiment is provided with a wireless sensor 9 secured to the chip 16, with the wave transmitter 15 configured to transmit waves 36, and the chip 16 is immobilized in the central region 24 of the body 5. FIG. 5 shows a single housing 18 delimited by the peripheral region 21 of the body 5.

FIG. 6 shows the body 5 of the simulation device 2 according to the second aspect of the invention and in a fifth embodiment. Said fifth embodiment is provided with a wired sensor 9 immobilized in the central region 24 of the body 5. FIG. 6 shows the housing 18 divided into a plurality of cavities 25 separated from one another by ribs 26. Each rib 26, made of the synthetic material 12, connects the central region 24 of the body 5 to the peripheral region 21 of the body 5, and also connects the upper region 19 of the body 5 to the lower region 20 of the body 5, which are not visible owing to the viewing angle. Therefore, each cavity 25 is independent of the other cavities 25 in being closed, and encloses a portion of the element 11. In this particular case, the ribs 26 are distributed in a regular star shape, such that the cavities 25 have equivalent volumes, for equivalent thermal conductivity. The number of cavities 25 may vary.

FIG. 7 shows the body 5 of the simulation device 2 according to the second aspect of the invention and in a sixth embodiment. Said sixth embodiment is provided with the wired sensor 9 immobilized in the central region 24 of the body 5. FIG. 7 shows a housing 18 divided into a plurality of cavities 25 separated from one another by ribs 26. Each rib 26, made of the synthetic material 12, is concentric with the central region 24 such that the cavities 25 correspond to concentric annular areas. Each rib 26 connects the upper region 19 of the body 5 to the lower region 20 of the body 5, which are not visible owing to the viewing angle. Therefore, each cavity 25 is closed and encloses a portion of the element 11. In this particular case, the distribution of the ribs 26 is regular, such that the cavities 25 have volumes that increase from the central region 24 to the peripheral region 21, for optimized thermal conductivity.

FIG. 8 is a diagrammatic view of the data acquisition station 4 comprised in the monitoring device 1 according to the second aspect of the invention.

The data acquisition station 4 comprises a data processing module 27, shown diagrammatically and transparently by dotted lines, the data processing module 27 being configured to process data measured by a sensor 9 of the simulation device 2, not shown here. As it stands, the sensor 9 is a wired sensor provided with an electric wire 3 connected to the data acquisition station 4 by connectors 28 of said data acquisition station 4. In the example shown in FIG. 8, four electric wires 29 are connected to four connectors 28. It will therefore be understood that this type of data acquisition station 4 is configured to be connected electrically to at least four simulation devices 2 according to the first aspect of the invention.

Each connector 28 of the data acquisition station 4 is connected electrically to the data processing module 27 of the data acquisition station 4 by an electric connection 37 internal to said data acquisition station 4.

The data acquisition station 4 comprises two data indicators 30, 31: an indicator light 30 and a value display 31. The data indicator 30, 31 which is a luminous indicator 30 is shown in FIG. 8 as comprising three light sources 32, for example LED light sources.

The data processing module 27 is configured to manage these data indicators 30, 31 via an internal electric network 33 of said data acquisition station 4.

The data acquisition station 4 also comprises a switch 34 used to cut or re-establish an electric power supply in the monitoring device 1 according to the second aspect of the invention.

FIG. 9 and FIG. 10 show two embodiments that differ from the first embodiment described in FIG. 1. In these two embodiments, the device 1 for monitoring the cooking of a food according to the second aspect of the invention comprising a plurality of simulation devices 2 according to the first aspect of the invention. These configurations allow the same data acquisition station 4 to be shared for taking a plurality of simultaneous measurements. Moreover, the cooking surface 13 of the cooking device 6 may be heated heterogeneously. It is therefore sensible to implement a plurality of simulation devices 2 at different points of the cooking surface 13 of the cooking device 6, for example in the center and at the periphery of the cooking surface 13.

For the same embodiment shown in FIG. 9 or in FIG. 10, the simulation devices 2 are identical in nature, specifically, in FIG. 9 the simulation devices 2 each comprise a wired sensor 9, and in FIG. 10 the simulation devices 2 each comprise a wireless sensor 9.

FIG. 9 shows nine simulation devices 2 according to the first aspect of the invention arranged in a network. Only one of the nine simulation devices 2 according to the first aspect of the invention is directly connected to the data acquisition station 4. The other simulation devices 2 according to the first aspect of the invention are indirectly connected to the data acquisition station 4. Whether direct or indirect, the connection is wired and depends on the electric wire 3 of the wired sensor 9.

FIG. 10 shows five simulation devices 2 according to the first aspect of the invention distributed on the cooking surface 13 of the cooking device 6. All are provided with a wireless sensor 9 connected by waves 36 to the same data acquisition station 4 which comprises a wave receiver 35.

To sum up, the invention relates to a device 2 for simulating a food comprising a sensor 9 that allows monitoring of an internal parameter of the simulation device 2, made of at least one synthetic material 12 and an element 11. The proportions by mass of synthetic material 12 and element 11, and also the type of synthetic material 12 and the type of liquid chosen, allow the behaviors of the foods to be mimicked, in particular during the cooking thereof and when said foods are subjected to temperature variations ranging from −20° C. to 110° C. According to the invention, the element 11 has a mass of between 30% and 77% of a dry mass of the synthetic material 12. The invention is particularly suited to meat foods comprising beef and/or poultry, but is suitable for any food for which the core cooking must be optimal, as is the case for foods preserved by freezing.

Of course, the invention is not limited to the examples that have just been described and numerous adaptations may be made to said examples without departing from the framework of the invention. In particular, the different characteristics, shapes, variants and embodiments of the invention may be associated with one another in various combinations provided that they are not incompatible or exclusive of one another. In particular, all the variants and embodiments described above may be combined with one another.

1. Device for simulating the thermophysical properties of a food, the simulation device comprising:
a body formed by:
at least one synthetic material, the at least one synthetic material being configured to be solid at a temperature of between −20° C. and 110° C.; and
an element housed in the body, the element being liquid at ambient temperature;
a sensor configured to measure data representative of a parameter of the body, the sensor being housed in the body.

2. Device for simulating a food according to claim 1, wherein the element is impregnated in the at least one synthetic material so as together to form an emulsion.

3. Device for simulating a food according to claim 1, wherein the sensor is a temperature sensor.

4. Device for simulating a food according to claim 1, wherein the at least one synthetic material comprises methylcellulose.

5. Device for simulating a food according to claim 1, wherein the element is between 70% and 80% of the dry mass of the at least one synthetic material.

6. Device for simulating a food according to claim 1, wherein the at least one synthetic material comprises silicon, the element being housed in a housing of the body.

7. Device for simulating a food according to claim 6, wherein the housing is divided into a plurality of cavities separated from one another by ribs.

8. Device for simulating a food according to claim 1, wherein the element comprises water.

9. Device for simulating a food according to claim 1, wherein the synthetic material comprises an additive in order to improve the thermal performance of the synthetic material.

10. Device for monitoring the cooking of a food comprising at least one simulation device according to claim 1, each simulation device being connected to a data acquisition station.

11. Device for monitoring the cooking of a food according to claim 10, wherein the data acquisition station comprises a data processing module, the data processing module being configured to process the data measured by a sensor of the simulation device.

12. Device for monitoring the cooking of a food according to claim 10, wherein the data acquisition station comprises a data indicator.
